(19) United States
(12) Patent Application Publication
(10) Pub. No.: US 2022/0326631 A1
(43) Pub. Date: Oct. 13, 2022

(54) ELECTROSTATIC CHARGE IMAGE DEVELOPING TONER AND ELECTROSTATIC CHARGE IMAGE DEVELOPER

(71) Applicant: Konica Minolta, Inc., Tokyo (JP)

(72) Inventors: Junya ONISHI, Tokyo (JP); Tatsuya FUJISAKI, Tokyo (JP); Kazumi OURA, Tokyo (JP); Kaori FUJINO, Tokyo (JP)

(21) Appl. No.: 17/656,578

(22) Filed: Mar. 25, 2022

(30) Foreign Application Priority Data
Apr. 9, 2021 (JP) 2021-066181

(51) Int. Cl. G03G 9/087; G03G 9/097; C08F 212/08; C08G 63/16; C08G 63/183

(52) U.S. Cl. CPC G03G 9/08755; G03G 9/08711; G03G 9/09733; C08F 212/08; C08G 63/16; C08G 63/183

(57) ABSTRACT

Provided is an electrostatic charge image developing toner containing at least toner particles, wherein the toner particles contain an amorphous vinyl resin, an amorphous polyester resin, a crystalline polyester resin, and an ester wax; the crystalline polyester resin is a crystalline polyester resin obtained by polycondensation of a dicarboxylic acid having a number of carbon atoms in the range of 9 to 14 and a dialcohol having a number of carbon atoms in the range of 9 to 14; the amorphous polyester resin is an amorphous polyester resin containing a constituent unit derived from a dicarboxylic acid having a number of carbon atoms in the range of 9 to 14 or a dialcohol having a number of carbon atoms in the range of 9 to 14; and a sum of the number of carbon atoms of the dicarboxylic acid and the dialcohol is in the range of 18 to 24.

### CROSS-REFERENCE TO RELATED APPLICATIONS

The entire disclosure of Japanese Patent Application No. 2021-066181 filed on Apr. 9, 2021 is incorporated herein by reference in its entirety.

### BACKGROUND

### Technological Field

The present invention relates to an electrostatic charge image developing toner and an electrostatic charge image developer. More specifically, the present invention relates to an electrostatic charge image developing toner which has good low-temperature fixability and is less likely to cause tacking.

### Description of the Related Art

In recent years, in an electrophotographic image forming apparatus, an electrostatic charge image developing toner (hereinafter, also simply referred to as a “toner”) that may be thermally fixed at low temperatures is required. For this reason, toners with improved low-temperature fixability have been proposed by adding crystalline substances or waxes with high plasticizing effects as fixing aids and to lower the melting temperature and melt viscosity of the binder resin (for example, refer to Patent Document 1: JP-A 2015-045850). While the toner containing such a fixing aid has good low-temperature fixability, the toner itself and the image after fixing become vulnerable to thermal stress. In particular, when continuously printing images with a large amount of toner, the images are piled up with latent heat, and the latent heat and the pressure from the weight of the paper cause adhesion between the image and the paper or the image and the image, which is called tacking.

Patent Document 2 (JP-A 2018-087901) proposes a toner that contains a crystalline polyester resin and has an exothermic peak top temperature and an exothermic peak half value width within a certain range when the toner is heated down by differential scanning calorimetry (DSC). Although such a toner has a higher crystallization temperature, the ratio of crystallization to the amount of crystalline polyester resin and mold release agent added is not taken into account. Even if the crystallization temperature of the toner is high, if the ratio of crystallization to the amount of additive is low, the resin layer will not solidify sufficiently and tacking will occur, so there is room for improvement.

### SUMMARY

The present invention was made in consideration of the above problems and circumstances, and the problem to be solved is to provide an electrostatic charge image developing toner and an electrostatic charge image developer that have good low-temperature fixability and are less likely to cause tacking.

In order to solve the above-mentioned problem, the inventor has studied the cause of the above-mentioned problem, and has found the following. The toner particles contained in the electrostatic charge image developing toner of the present invention contain an amorphous vinyl resin, an amorphous polyester resin, a crystalline polyester resin and an ester wax, wherein the crystalline polyester resin is a crystalline polyester resin obtained by polycondensation of a dicarboxylic acid and a dialcohol having a number of carbon atoms within a specific range, and the amorphous polyester resin is an amorphous polyester resin containing a constituent unit derived from a dicarboxylic acid or a dialcohol with a number of carbon atoms within a specific range. This led to the present invention. In other words, the above issues related to the present invention are solved by the following means.

To achieve at least one of the above-mentioned objects of the present invention, an electrostatic charge image developing toner that reflects an aspect of the present invention is as follows.

An electrostatic charge image developing toner comprising at least toner particles,

wherein the toner particles contain an amorphous vinyl resin, an amorphous polyester resin, a crystalline polyester resin, and an ester wax;

the crystalline polyester resin is a crystalline polyester resin obtained by polycondensation of a dicarboxylic acid having a number of carbon atoms in the range of 9 to 14 and a dialcohol having a number of carbon atoms in the range of 9 to 14;

the amorphous polyester resin is an amorphous polyester resin containing a constituent unit derived from a dicarboxylic acid having a number of carbon atoms in the range of 9 to 14 or a dialcohol having a number of carbon atoms in the range of 9 to 14; and

a sum of the number of carbon atoms of the dicarboxylic acid and the number of carbon atoms of the dialcohol is in the range of 18 to 24.

By the above means of the present invention, it is possible to provide an electrostatic charge image developing toner and an electrostatic charge image developer that have good low-temperature fixability and are less likely to cause tacking.

Although the mechanism of expression or the mechanism of action of the effect of the present invention has not been clarified, it is inferred as follows.

Tacking occurs when the crystalline substances (a crystalline polyester resin and a wax) in the toner do not fully crystallize by the time the high-temperature images are stacked after fixing, and the viscosity of the resin layer decreases, causing the images to adhere to each other. Therefore, after fixing, tacking may be suppressed when the crystalline substance in the toner crystallizes at a high temperature and at a high ratio with respect to the amount added.

Depending on the chain length (number of carbon atoms) of the dialcohol and the dicarboxylic acid that constitute the crystalline polyester resin, the temperature at which crystallization occurs after fixing and the degree of crystallization may be controlled. The larger the number of carbon atoms, the higher the crystallization temperature, and the higher the crystallization ratio. However, at the same time, the compatibility with the binder resin deteriorates, so the viscosity of the binder resin does not drop sufficiently during fixing, and the low-temperature fixability deteriorates. Therefore, in order to solve this problem, it is necessary to facilitate crystallization without reducing the compatibility between the crystalline material and the binder resin.

By having an amorphous polyester resin with a constituent unit similar to those of the crystalline polyester resin in the binder resin of the toner, it is possible to achieve both compatibility with the crystalline polyester resin during fixing and ease of crystallization after fixing. This is because, during fixing, the crystalline polyester resin is selectively compatible with the constituent unit sites of the amorphous polyester resin that are similar to those of the crystalline polyester resin, lowering the viscosity of the binder resin. In addition, after fixing, the crystalline polyester resin concentration is locally high due to the selective compatibility, and crystallization can easily occur.

Furthermore, it was found that the effect of the invention is particularly excellent when the chain length (number of carbon atoms) of the dialcohol and dicarboxylic acid constituting the crystalline polyester resin are both in the range of 9 to 14. We believe that this is due to the uniformity of the ester group distribution, which makes crystallization easier. When the total number of carbon atoms of the dialcohol and dicarboxylic acid used in the crystalline polyester resin is smaller than 18, tacking is more likely to occur. When the total number is larger than 24, we found that the compatibility will be deteriorated and fixability will be deteriorated.

It is believed that these expression or action mechanisms can provide an electrostatic charge image developing toner that has good low-temperature fixability and is less likely to cause tacking.

### DETAILED DESCRIPTION OF THE EMBODIMENTS

Hereinafter, one or more embodiments of the present invention will be described. However, the scope of the invention is not limited to the disclosed embodiments.

The electrostatic charge image developing toner of the present invention is an electrostatic charge image developing toner containing at least toner particles, wherein the toner particles contain an amorphous vinyl resin, an amorphous polyester resin, a crystalline polyester resin and an ester wax, the crystalline polyester resin being a crystalline polyester resin obtained by polycondensation of a dicarboxylic acid having a number of carbon atoms in the range of 9 to 14 and a dialcohol having a number of carbon atoms in the range of 9 to 14; the amorphous polyester resin is an amorphous polyester resin containing a constituent unit derived from a dicarboxylic acid having a number of carbon atoms in the range of 9 to 14 or a dialcohol having a number of carbon atoms in the range of 9 to 14, and a sum of the number of carbon atoms of the dicarboxylic acid and the number of carbon atoms of the dialcohol is in the range of 18 to 24. This feature is a technical feature common to or corresponding to the following embodiments.

As an embodiment of the electrostatic charge image developing toner of the present invention, 50 mass % or more of the total amount of the crystalline polyester resin is a crystalline polyester resin obtained by polycondensation of a dicarboxylic acid having a number of carbon atoms in the range of 9 to 14 and a dialcohol having a number of carbon atoms in the range of 9 to 14. It is preferable from the viewpoint of achieving both low-temperature fixability and suppression of tacking.

As an embodiment of the electrostatic charge image developing toner of the present invention, it is preferable that all of the crystalline polyester resin is a crystalline polyester resin obtained by polycondensation of a dicarboxylic acid having a number of carbon atoms in the range of 9 to 14 and a dialcohol having a number of carbon atoms in the range of 9 to 14. It is preferable from the viewpoint of achieving both low-temperature fixability and suppression of tacking.

As an embodiment of the electrostatic charge image developing toner of the present invention, it is preferable that the acid number of the aforementioned crystalline polyester resin is in the range of 20 to 30 mg KOH/g from the viewpoint of achieving both low-temperature fixability and manufacturing stability.

As an embodiment of the electrostatic charge image developing toner of the present invention, it is preferable that the amorphous polyester resin is an amorphous polyester resin containing 1 to 20 mol % of a constituent unit derived from a dicarboxylic acid having a number of carbon atoms in the range of 9 to 14 or a dialcohol having a number of carbon atoms in the range of 9 to 14 from the viewpoint of achieving both low-temperature fixability and suppression of tacking.

As an embodiment of the electrostatic charge image developing toner of the present invention, it is preferable that the number of carbon atoms of the dicarboxylic acid having the number of carbon atoms in the range of 9 to 14 and the number of carbon atoms of the dialcohol having the number of carbon atoms in the range of 9 to 14 are the same. It is preferable from the viewpoint of achieving both low-temperature fixability and suppression of tacking.

As an embodiment of the electrostatic charge image developing toner of the present invention, it is preferable that the dicarboxylic acid having the number of carbon atoms in the range of 9 to 14 is sebacic acid, and the dialcohol having the number of carbon atoms in the range of 9 to 14 is 1,10-decanediol from the viewpoint of achieving both low-temperature fixability and suppression of tacking.

As an embodiment of the electrostatic charge image developing toner of the present invention, it is preferable that the crystalline polyester resin is a hybrid crystalline polyester resin in which a crystalline polyester polymer segment and a vinyl polymer segment having a constituent unit derived from styrene are chemically bonded from the viewpoint of low-temperature fixability.

As an embodiment of the electrostatic charge image developing toner of the present invention, it is preferable that the amorphous polyester resin is a hybrid amorphous polyester resin in which an amorphous polyester polymer segment and a vinyl polymer segment having a constituent unit derived from styrene are chemically bonded from the viewpoint of low-temperature fixability.

As an embodiment of the electrostatic charge image developing toner of the present invention, it is preferable that the value of the ratio Wₐₚ/W_{cp} of the content Wₐₚ of the amorphous polyester resin and the content W_{cp} of the crystalline polyester resin is in the range off 0.5 to 1.5 from the viewpoint of achieving both low-temperature fixability and suppression of tacking.

As an embodiment of the electrostatic charge developing toner of the present invention, it is preferable to further contain Fischer-Tropsch wax from the viewpoint of suppression of tacking.

The electrostatic charge image developer of the present invention (hereinafter simply referred to as the “developer”) is characterized in that it contains the electrostatic charge image developing toner of the present invention.

The following is a detailed description of the invention and its components, as well as forms and modes for carrying out the invention. In this application, “to” is used in the sense that it includes the numerical values described before and after it as the lower and upper limits.

### <<Outline of Electrostatic Charge Image Developing Toner>>

The electrostatic charge image developing toner of the present invention is an electrostatic charge image developing toner containing at least toner particles, wherein the toner particles contain an amorphous vinyl resin, an amorphous polyester resin, a crystalline polyester resin and an ester wax, the crystalline polyester resin being a crystalline polyester resin obtained by polycondensation of a dicarboxylic acid having a number of carbon atoms in the range of 9 to 14 and a dialcohol having a number of carbon atoms in the range of 9 to 14, the amorphous polyester resin being an amorphous polyester resin containing a constituent unit derived from a dicarboxylic acid having a number of carbon atoms in the range of 9 to 14 or a dialcohol having a number of carbon atoms in the range of 9 to 14, and a sum of the number of carbon atoms of the dicarboxylic acid and the number of carbon atoms of the dialcohol is preferably in the range of 18 to 24.

When the total number of carbon atoms of the dialcohol and dicarboxylic acid used in the crystalline polyester resin is less than 18, tacking is likely to occur. When the total number of carbon atoms of the dialcohol and dicarboxylic acid used is larger than 24, the compatibility will be deteriorated and fixability will be deteriorated. Further, the smaller the difference in the number of carbon atoms between the dialcohol and the dicarboxylic acid, the higher the uniformity of the ester group distribution and the easier it is to crystallize Therefore, the number of each carbon atom is preferably in the range of 9 to 14. Thereby, tacking may be suppressed.

In the present invention, “an electrostatic charge image developing toner” means an aggregate of toner base particles or toner particles. Here, “toner particles” are preferably toner base particles to which an external additive has been added, but the toner base particles may also be used as toner particles as they are. In the present invention, toner base particles, toner particles, and a toner are also referred to simply as a “toner” when there is no need to distinguish between them.

### <<Binder Resin>>

The toner particles of the present invention contain an amorphous vinyl resin, an amorphous polyester resin, and a crystalline polyester resin as a binder resin.

The content of the binder resin in the toner particles is preferably 70 to 95 mass % with respect to the total amount of the toner particles.

The content of amorphous vinyl resin in the binder resin is preferably 10 to 90 mass % with respect to the total amount of the binder resin.

The content of amorphous polyester resin in the binder resin is preferably 10 to 90 mass % with respect to the total amount of the binder resin.

The content of crystalline polyester resin in the binder resin is preferably 1 to 20 mass % with respect to the total amount of the binder resin.

It is preferable that the value of the ratio Wₐₚ/W_{cp} of the content Wₐₚ of the amorphous polyester resin to the content W_{cp} of the crystalline polyester resin in the toner particle is in the range of 0.5 to 1.5, from the viewpoint of achieving both low-temperature fixability and suppression of tacking.

### <Crystalline Polyester Resin>

Crystalline polyester resins are polyester resins obtained by polycondensation reactions of polyvalent carboxylic acids and polyhydric alcohols that exhibit crystalline properties.

Crystallinity is defined as having a clear endothermic peak in the endothermic curve obtained by DSC, rather than a staircase-like endothermic change at the melting point or when the temperature is raised. A clear endothermic peak means a peak with a half value width of 15° C. or less in the endothermic curve when the temperature is raised at a rate of 10 ° C./min.

### (Crystalline Polyester Resin A)

The crystalline polyester resin of the present invention is a crystalline polyester resin obtained by polycondensation of a dicarboxylic acid having a number of carbon atoms in the range of 9 to 14 and a dialcohol having a number of carbon atoms in the range of 9 to 14. A sum of the number of carbon atoms of the dicarboxylic acid and the number of carbon atoms of the dialcohol is in the range of 18 to 24. The crystalline polyester resin that satisfies these conditions is hereinafter referred to as “crystalline polyester resin A”. A crystalline polyester resin A may use components other than dicarboxylic acid and dialcohol with carbon atoms in the range of 9 to 14 as raw material monomers.

The total number of carbon atoms of the dialcohol and dicarboxylic acid used in the crystalline polyester resin A is more preferably in the range of 18 to 22 from the viewpoint of achieving low-temperature fixability.

Of the total amount of crystalline polyester resin contained in the toner particles of the present invention, it is preferable that the ratio of crystalline polyester resin A is 50 mass % or more, and a more preferable ratio is 70% or more, and an even more preferable ratio is 90% or more. It is most preferable that all of the total amount of crystalline polyester resin contained in the toner particles of the present invention is crystalline polyester resin A. The higher the percentage of crystalline polyester resin A, the higher the effect of the present invention.

In the crystalline polyester resin A, from the viewpoint of achieving both low-temperature fixability and suppression of tacking, in the polyvalent carboxylic acid which is a raw material monomer, the higher the ratio of dicarboxylic acid having a number of carbon atoms in the range of 9 to 14, the better. Specifically, it is preferable to be 90 mol % or more. Further, in the polyhydric alcohol which is a raw material monomer, the higher the ratio of the dialcohol having a number of carbon atoms in the range of 9 to 14, the better, and specifically, it is preferable to be 90 mol % or more.

As dicarboxylic acids having a number of carbon atoms in the range of 9 to 14, the following linear dicarboxylic acids are preferred.

9 carbon atoms: Azelaic acid (nonanedioic acid, 1,7-heptanedicarboxylic acid)

10 carbon atoms: Sebacic acid (decanedioic acid, 1,8-octanedicarboxylic acid)

11 carbon atoms: Undecanedioic acid (undecanedioic acid, 1,9-nonanedicarboxylic acid)

12 carbon atoms: Dodecanedioic acid (dodecanedioic acid, 1,10-decanedicarboxylic acid)

13 carbon atoms: Tridecanedioic acid (tridecanedioic acid, 1,11-undecanedicarboxylic acid)

14 carbon atoms: Tetradecanedioic acid (tetradecanedioic acid, 1,12-dodecanedicarboxylic acid)

The following linear dialcohols are preferred as dialcohols having a number of carbon atoms in the range of 9 to 14.

9 carbon atoms: 1,9-Nonanediol

10 carbon atoms: 1,10-Decanediol

11 carbon atoms: 1,11 -Undec anediol

12 carbon atoms: 1,12-Dodecanediol

13 carbon atoms: 1,13-Tridecanediol

14 carbon atoms: 1,14-Tetradecanediol

In the crystalline polyester resin A, from the viewpoint of achieving both low-temperature fixability and suppression of tacking, the higher the proportion of the dicarboxylic acid having a number of carbon atoms in the range of 9 to 14 among the polyvalent carboxylic acids which are the raw material monomers to be polycondensed, the better. Further, in the crystalline polyester resin, 90 mol % or more of the polyhydric alcohol which is a raw material monomer to be polycondensed is preferably a dialcohol having a number of carbon atoms in the range of 9 to 14.

For crystalline polyester resin A, it is preferable that the number of carbon atoms of the dicarboxylic acid, which is the raw material monomer to be polymerized, and the number of carbon atoms of the dialcohol are the same from the viewpoint of achieving both low-temperature fixability and suppression of tacking. It is also particularly preferred that the crystalline polyester resin A is a crystalline polyester resin obtained by polycondensation of sebacic acid and 1,10-decanediol.

### (Other Crystalline Polyester Resins)

For crystalline polyester resins other than crystalline polyester resin A that may be included in the toner particles of the present invention, the raw material monomers to be polycondensed are not particularly limited.

Examples of the polyvalent carboxylic acid include aliphatic dicarboxylic acids such as oxalic acid, malonic acid, succinic acid, adipic acid, sebacic acid, azelaic acid, n-dodecylsuccinic acid, nonanedicarboxylic acid, decanedicarboxylic acid, undecanedicarboxylic acid, dodecanedicarboxylic acid, and tetradecanedicarboxylic acid; alicyclic dicarboxylic acids such as cyclohexane dicarboxylic acid; aromatic dicarboxylic acids such as phthalic acid, isophthalic acid, terephthalic acid; trivalent or higher polyvalent carboxylic acids such as trimellitic acid, and pyromellitic acid. Anhydrides of these carboxylic acid compounds, or alkyl esters with one to three carbons may be used. One or more of these may be used alone or in combination.

Examples of the polyhydric alcohol include aliphatic diols such as 1,2-propanediol, 1,3-propanediol, 1,4-butanediol, 1,5-pentanediol, 1,6-hexanediol, 1,7-heptanediol, and 1,8-octanediol, 1,9-nonanediol, dodecanediol, neopentyl glycol, and 1,4-butenediol; and polyhydric alcohols of trivalent value or higher such as glycerin, pentaerythritol, trimethylolpropane, and sorbitol. One of these may be used alone, or two or more may be used in combination.

### (Synthetic Method of Crystalline Polyester Resin)

Crystalline polyester resins may be synthesized by polycondensation (esterification) of the above polyhydric alcohol component and polyvalent carboxylic acid component using a known esterification catalyst.

As the ratio of the polyhydric alcohol component to the polyvalent carboxylic acid component, the equivalent ratio of the hydroxy group of the polyhydric alcohol component to the carboxy group of the polyvalent carboxylic acid component is preferably in the range of 1.5/1 to 1/1.5, and more preferably in the range of 1.2/1 to 1/1.2.

Catalysts that may be used in the synthesis of crystalline polyester resins include alkaline metal compounds such as sodium and lithium; alkaline earth metal compounds such as magnesium and calcium; metal compounds such as aluminum, zinc, manganese, antimony, titanium, tin, zirconium, and germanium, phosphite compounds, phosphate compounds, and amine compounds. Examples of the titanium compounds include titanium alkoxides such as tetranormal butyl titanate, tetraisopropyl titanate, tetramethyl titanate, and tetrastearyl titanate; titanium acylates such as polyhydroxytitanium stearate; titanium chelates such as such as titanium lactate and titanium triethanolamine may be mentioned. As germanium compounds, germanium dioxide may be mentioned. As aluminum compounds, oxides such as polyaluminum hydroxide, aluminum alkoxide, and tributylaluminate, may be mentioned. These may be used alone or in combination of two or more types.

The polymerization temperature and time are not particularly limited, and the reaction system may be depressurized as necessary during polymerization.

### (Acid Value of Crystalline Polyester Resin)

The acid number of the crystalline polyester resin in the present invention is preferably in the range of 20 to 30 mg KOH/g from the viewpoint of low-temperature fixability and manufacturing stability.

The acid value is the mass of potassium hydroxide (KOH) required to neutralize the acid contained in a 1 g of sample, expressed in mg. The acid value of the resin is measured by the following procedure according to JIS K0070-1966.

### [Preparation of Reagents]

1.0 g of phenolphthalein is dissolved in 90 mL of ethyl alcohol (95% by volume), and ion-exchanged water is added to make 100 mL, to prepare a phenolphthalein solution. 7 g of JIS special grade potassium hydroxide is dissolved in 5 mL of ion-exchanged water, and ethyl alcohol (95% by volume) is added to make 1 liter. Then, the solution is left in an alkali-resistant container for 3 days to prevent exposure to carbon dioxide gas, and then it is filtered to prepare potassium hydroxide solution. The standardization follows the description of JIS K0070-1966.

### [Main Test]

2.0 g of the crushed sample is weighted in a 200 mL triangular flask, 100 mL of a mixed solution of toluene/ ethanol (2:1) is added. Then it is dissolved for 5 hours. Subsequently, a few drops of phenolphthalein is added and titration is done with prepared potassium hydroxide solution. The endpoint of titration should be when the indicator turns light red for about 30 seconds.

### [Empty Test]

The same operation is performed as in this test above, except that no sample is used (i.e., only a mixed solution of toluene/ethanol (2:1)).

### [Calculation]

Substitute the titration results of the main test and the empty test into the following equation (1) to calculate the acid value.

A=[(B−C)×f×5.6]/S Equation (1)

A: Acid value (mg KOH/g)

B: Amount of potassium hydroxide solution added during empty test (mL)

C: Amount of potassium hydroxide solution added at the time of this test (mL)

f: Factor of 0.1 mol/liter potassium hydroxide ethanol solution.

S: Mass of the sample (g)

### (Weight Average Molecular Weight of Crystalline Polyester Resin)

The weight average molecular weight of the crystalline polyester resin is preferably in the range of 1000 to 29000. When it is 1000 or more, the crystalline polyester resin does not dissolve too much after melting, crystallization progresses, and it is superior in terms of suppression of tacking. When it is less than 29000, the crystalline polyester resin easily melts during melting, and is superior in terms of low-temperature fixability.

The method for measuring the weight average molecular weight of crystalline polyester resin is as follows.

Gel permeation chromatography (HLC-8320 GPC: Tosoh Corporation), one column of “TSKgel guard column SuperHZ-L” and three columns of “TSKgel SuperHZM-M” (both manufactured by Tosoh Corporation) may be used for the measurement.

The column (TSK-) is stabilized at 40° C., and tetrahydrofuran (THF) is added as a carrier solvent to the column at this temperature at a flow rate of 0.35 mL/min. min. The THF sample solution of the measurement sample (resin) is adjusted to a sample concentration of 1 mg/mL. Process the sample solution for 10 minutes at room temperature using a roll mill, and then process it through a membrane filter with a pore size of 0.2 μm to obtain the sample solution. 10 μL of this sample solution is injected into the device together with the carrier solvent described above and detected using a refractive index detector (RI detector).

The molecular weight distribution of the measurement sample is calculated based on a calibration curve prepared using a polystyrene standard sample with a monodisperse molecular weight distribution. The calibration curve is based on 10 samples of the “polystyrene standard sample TSK standard”: “A-500”, “F-1”, “F-10”, “F-80”, “F-380”, “A-2500”, “F-4”, “F-40”, “F-128” and “F-700”. The data collection interval for sample analysis is made to be 300 ms.

The weight average molecular weight of the crystalline polyester resin may be calculated by the measurement method described above after separating the crystalline polyester resin from the mold release agent in the toner as follows. First, the toner is dispersed in ethanol, which is a poor solvent for toner, and the temperature is raised to a temperature exceeding the melting point of the crystalline polyester resin and wax. At this time, pressure may be applied as necessary. At this point, the crystalline polyester resin and wax that have exceeded the melting point are melted. The mixture of crystalline polyester resin and wax may then be extracted from the toner by solid-liquid separation. The mixture may be sorted by molecular weight to separate the crystalline polyester resin from the wax.

### (Melting Point of Crystalline Polyester Resin)

The melting point (Tm) of the crystalline polyester resin is preferably in the range of 55 to 90° C., and more preferably in the range of 70 to 85° C., from the viewpoint of obtaining sufficient low-temperature fixability and excellent hot-offset resistance. The melting point of crystalline polyester resin may be controlled by the resin composition.

The melting point (Tm) is a temperature of the peak top of the endothermic peak, and may be measured by DSC.

Specifically, the sample is sealed in an aluminum pan KIT NO. B0143013 and placed in the sample holder of the thermal analyzer Diamond DSC (manufactured by Perkin Elmer Corporation), and change the temperature in the order of heating, cooling, and heating. In the first heating, the temperature is increased from room temperature (25° C.). In the second heating, the temperature is raised from 0° C. to 150° C. at a rate of 10° C./min and held at 150° C. for 5 minutes. During cooling, the temperature is lowered from 150° C. to 0 ° C. at a rate of 1° C./min. The temperature at the peak top of the endothermic peak in the endothermic curve obtained during the second heating is measured as the melting point.

### (Hybrid Crystalline Polyester Resin)

The crystalline polyester resin A contained in the toner particles of the present invention is preferably a hybrid crystalline polyester resin in which a crystalline polyester polymer segment and an amorphous polymer segment are chemically bonded, from the viewpoint of low-temperature fixability. It is particularly preferred that the amorphous polymer segment is a vinyl polymer segment with a constituent unit derived from styrene.

The term “crystalline polyester polymer segment” refers to a portion derived from a crystalline polyester resin. That is, it means a molecular chain with the same chemical structure as the molecular chain that constitutes the crystalline polyester resin described above. The term “amorphous polymer segment” refers to a portion derived from an amorphous resin. In other words, it means a molecular chain with the same chemical structure as the molecular chain that constitutes the amorphous resin.

There are no restrictions on the chemically bonded structure, and it may be a block copolymer or a graft copolymer. It is preferable that the crystalline polyester polymer segment is grafted to the amorphous polymer segment as the main chain. In other words, the hybrid crystalline polyester resin is preferably a graft copolymer having the amorphous polymer segment as the main chain and the crystalline polyester polymer segment as the side chain.

The crystalline polyester polymer segment is the same as the crystalline polyester resin described above, and it is the portion derived from the polyester resin obtained by polycondensation reaction of the polyvalent carboxylic acid and polyhydric alcohol described above. The crystalline polyester polymer segment may be synthesized from a polyvalent carboxylic acid and a polyhydric alcohol in the same manner as the crystalline polyester resin described above.

The content of the crystalline polyester polymer segment is preferably between 80 mass % and 98 mass % of the total amount of the hybrid crystalline polyester resin, and it is more preferable that the content is between 90 mass % and 95 mass %. By using the above range, sufficient crystallinity may be imparted to the hybrid crystalline polyester resin.

It is preferable that the amorphous polymer segment is composed of the same type of resin as the amorphous resin (e.g., amorphous vinyl resin, amorphous polyester resin) contained in the toner particles as the binder resin, from the viewpoint of improving the affinity with the binding resin and enhancing the charging uniformity of the toner. In this form, the affinity between the hybrid crystalline polyester resin and the amorphous resin is further improved. The term “same type of resin” refers to resins that have characteristic chemical bonds in their repeating units.

The meaning of “the characteristic chemical bond” is determined by “polymer classification” indicated in a database provided by National Institute for Material Science (NIMS): (http://polymer.nims.gojp/PoLyInfo/guide/jp/term_polymer.html). Namely, the chemical bonds which constitute the following 22 kinds of polymers are called as “the characteristic chemical bonds”: polyacryls, polyamides, polyacid anhydrides, polycarbonates, polydienes, polyesters, poly-halo-olefins, polyimides, polyimines, polyketones, polyolefins, polyethers, polyphenylenes, polyphosphazenes, polysiloxanes, polystyrenes, polysulfides, polysulfones, polyurethanes, polyureas, polyvinyls and other polymers.

When the resin is a copolymer, “resins of the same kind” means resins that have characteristic chemical bonds in common when the constituent units are monomer species having the above chemical bonds in the chemical structure of the plurality of monomer species constituting the copolymer. Therefore, even if the properties shown by the resins themselves are different from each other or the molar component ratios of the monomer species constituting the copolymer are different from each other, they are considered to be the same type of resin if they have the characteristic chemical bond in common.

For example, the resin (or polymer segment) formed by styrene, butyl acrylate and acrylic acid and the resin (or polymer segment) formed by styrene, butyl acrylate and methacrylic acid have at least a chemical bond constituting a polyacrylic resin, therefore they are the same type of resin. As a further example, the resin (or polymer segment) formed by styrene, butyl acrylate, and acrylic acid and the resin (or polymer segment) formed by styrene, butyl acrylate, acrylic acid, terephthalic acid, and fumaric acid have a chemical bonds common to each other. That is, they have at least one chemical bond that constitutes a polyacrylic resin. Therefore, they are the same type of resin.

It is preferred that the amorphous polymer segment further contains an amphoteric compound in the monomer, from the viewpoint of introducing a chemical bonding site with the above crystalline polyester polymer segment into the above amorphous polymer segment. The content of the constituent unit derived from the above amphoteric compound in the amorphous polymer segment is preferably 0.5 mass % to 20 mass %.

The “amphoteric compound” in the present invention is a monomer that binds a crystalline polyester polymer segment and an amorphous polymer segment. It has a hydroxy group, a carboxy group, an epoxy group, a primary amino group, or a secondary amino group that can react with the crystalline polyester polymer segment and an ethylenically unsaturated group capable of reacting with an amorphous polymer segment in the molecule. Of these, a vinyl carboxylic acid having a hydroxy group or a carboxy group and an ethylenically unsaturated group is preferable.

As the amphoteric compounds, for example, (meth)acrylic acid, fumaric acid, and maleic acid may be used, and their hydroxyalkyl (1 to 3 carbon atoms) esters may also be used. From the viewpoint of reactivity, acrylic acid, methacrylic acid or fumaric acid is preferred.

From the viewpoint of providing sufficient crystallinity to the hybrid crystalline polyester resin, the content of the amorphous polymer segment in the hybrid crystalline polyester resin is between 2 mass % and 20 mass %, preferably between 3 mass % and 15 mass %, more preferably between 5 mass % and 10 mass %, and particularly preferably between 7 mass % and 9 mass %.

The resin components that constitute the amorphous polymer segment are not particularly limited, but include, for example, a vinyl polymer segment, a urethane polymer segment, and a urea polymer segment. Among these, a vinyl polymer segment is preferred due to the ease of controlling the thermoplasticity.

The vinyl polymer segment may be any polymer of vinyl compounds, such as an acrylic ester polymer segment, a styrene-acrylic ester polymer segment, an ethylene-vinyl acetate polymer segment. One of these may be used alone, or two or more may be used in combination.

Among the vinyl polymer segments, those having a constituent unit derived from styrene are preferable in consideration of plasticity during heat fixing. In the following, the styrene-acrylic polymer segment will be described as an amorphous polymer segment having a constituent unit derived from styrene.

The styrene-acrylic polymer segment is formed by the addition polymerization of at least a styrene monomer and a (meth)acrylic ester monomer. The styrene monomer referred to here includes styrene represented by the structural formula CH₂=CH—C₆H₅, as well as styrene structures having known side chains or functional groups in the styrene structure. The (meth)acrylic acid ester monomer here includes acrylic acid ester compounds represented by CH₂═CHCOOR (R is an alkyl group) and methacrylic acid ester compounds, as well as ester compounds with known side chains or functional groups in the structure, such as acrylic acid ester derivatives and methacrylic acid ester derivatives.

The following are specific examples of styrene monomers and (meth)acrylic ester monomers that may be used to form styrene-acrylic polymer segments used in the present invention. However, the ones that may be used for forming the styrene-acrylic polymer segment used in the present invention are not limited to the following.

Specific examples of the styrene monomer include styrene, o-methylstyrene, m-methylstyrene, p-methylstyrene, α-methylstyrene, p-phenylstyrene, p-ethylstyrene, 2,4-dimethylstyrene, and p-tert-butylstyrene, p-n-hexylstyrene, p-n-octylstyrene, p-n-nonylstyrene, p-n-decylstyrene, and p-n-dodecylstyrene. These styrene monomers may be used alone or in combination of two or more.

Specific examples of the (meth)acrylic ester monomer include acrylic ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; methacrylic ester monomers such as methyl methacrylate, ethyl methacrylate, n-butyl methacrylate, isopropyl methacrylate, isobutyl methacrylate, t Ethyl methacrylate, isopropyl methacrylate, isobutyl methacrylate, t-butyl methacrylate, n-octyl methacrylate, 2-ethylhexyl methacrylate, stearyl methacrylate, lauryl methacrylate Phenyl methacrylate, diethylaminoethyl methacrylate, and dimethylaminoethyl methacrylate. Of these, it is preferable to use long-chain acrylic acid ester monomers. Specifically, methyl acrylate, n-butyl acrylate, and 2-ethylhexyl acrylate are preferred.

The constituent (chemical structure) and content of each segment in the hybrid crystalline polyester resin (or toner) may be identified by using known analytical methods such as nuclear magnetic resonance (NMR) measurement, methylation reaction pyrolysis gas chromatography/mass spectrometry (Py-GC/MS), and other known analysis methods.

The synthetic method of the hybrid crystalline polyester resin is not particularly limited, as long as the method is capable of forming a polymer with a structure in which the above crystalline polyester polymer segment and the amorphous polymer segment are chemically bonded. As a specific synthesis method of the hybrid crystalline polyester resin, for example, it may be synthesized by the first to third synthesis methods shown below.

### [First Synthetic Method]

The first synthetic method is to synthesize a hybrid crystalline polyester resin by conducting a polymerization reaction to synthesize a crystalline polyester polymer segment in the presence of a pre-synthesized amorphous polymer segment.

### [Second Synthetic Method]

The second synthetic method is to form a crystalline polyester polymer segment and an amorphous polymer segment, respectively, and then combine them to synthesize a hybrid crystalline polyester resin.

### [Third Synthetic Method]

The third synthetic method is to synthesize a hybrid crystalline polyester resin through a polymerization reaction that synthesizes an amorphous polymer segment in the presence of a crystalline polyester polymer segment.

Among the above synthetic methods from the first to the third, the first synthesis method is preferred because it is easier to synthesize hybrid crystalline polyester resin with a structure in which crystalline polyester polymer chains (crystalline polyester resin chains) are grafted onto amorphous polymer chains (amorphous resin chains). It is preferable since it simplifies the production process. In the first production method, since the amorphous polymer segment is formed in advance and then the crystalline polyester polymer segment is bonded, the orientation of the crystalline polyester polymer segment may be easily made uniform. Therefore, it is preferable from the viewpoint of reliably synthesizing a hybrid crystalline polyester resin suitable for the above-mentioned toner.

### <Amorphous Polyester Resin>

An amorphous polyester resins is a polyester resin obtained by a polycondensation reaction of a polyvalent carboxylic acid and a polyhydric alcohol, which exhibits amorphous properties.

The term “exhibit amorphous properties” means that the material has a glass transition point (Tg) in the endothermic curve obtained by differential scanning calorimetry (DSC), but does not have a melting point. That is, it does not have a clear endothermic peak at the time of temperature rise. A clear endothermic peak means an endothermic peak with a half value width of 15° C. or less in the endothermic curve when the temperature is raised at a rate of 10° C./min.

The toner particles of the present invention are characterized in that they contain an amorphous polyester resin containing a constituent unit derived from a dicarboxylic acid having a number of carbon atoms in the range of 9 to 14 or a dialcohol having a number of carbon atoms in the range of 9 to 14. This enables both compatibility with the crystalline polyester resin during fixing and ease of crystallization after fixing.

In addition, the toner particles may contain 1 to 20 mol % of a constituent unit derived from a dicarboxylic acid having a number of carbon atoms in the range of 9 to 14 or a dialcohol having a number of carbon atoms in the range of 9 to 14, relative to the total amount of amorphous polyester resin contained in the toner particles. This is preferable from the viewpoint of achieving both low-temperature fixability and suppression of tacking. Furthermore, it is more preferably to contain the constituent unit in the range of 4 to 16 mol %.

From the viewpoint of the effect of the present invention, the constituent unit derived from a dicarboxylic acid having a number of carbon atoms in the range of 9 to 14 or a dialcohol having a number of carbon atoms in the range of 9 to 14 contained in the amorphous polyester resin is preferably the constituent unit derived from the same dicarboxylic acid or dialcohol as the raw material monomer of the crystalline polyester resin A. For example, when the raw material monomers of the crystalline polyester resin A are sebacic acid and 1,10-decanediol, the amorphous polyester resin preferably contains a constituent unit derived from at least one of sebacic acid or 1,10-decanediol.

Examples of a polyvalent carboxylic acid other than the dicarboxylic acid from which the constituent unit is derived include phthalic acid, isophthalic acid, terephthalic acid, trimellitic acid, naphthalene-2,6-dicarboxylic acid, malonic acid, mesaconic acid, dimethyl isophthalate, fumaric acid, and dodecenyl succinic acid.

Examples of a polyhydric alcohols other than dicarboxylic acids from which the constituent units are derived include ethylene glycol, propylene glycol, 1,4- include butanediol, 2,3-butanediol, diethylene glycol, triethylene glycol, 1,5-pentanediol, 1,6-hexanediol, neopentyl glycol, 1,4-cyclohexanedimethanol, dipropylene glycol, polyethylene glycol, polypropylene glycol, ethylene oxide adduct of bisphenol A (BPA-EO), propylene oxide adduct of bisphenol A (BPA-PO), glycerin, sorbitol, 1,4-sorbitan, and trimethylolpropane.

(Synthetic method of amorphous polyester resin)

The synthetic method of amorphous polyester resin is not particularly limited and may be synthesized by polycondensation (esterification) of the above polyhydric alcohol component and polyvalent carboxylic acid component using known esterification catalysts such as those described above.

The polymerization temperature and time are not particularly limited, and the reaction system may be depressurized as necessary during polymerization.

### (Weight Average Molecular Weight of Amorphous Polyester Resin)

The weight average molecular weight (Mw) of the amorphous polyester resin is preferably in the range of 10000 to 100000. The weight average molecular weight of amorphous polyester resins may be measured in the same way as the weight average molecular weight of the crystalline polyester resin described above.

### (Glass Transition Temperature of Amorphous Polyester Resin)

The glass transition point (Tg) of the amorphous polyester resin is preferably in the range of 25 to 60° C. in order to achieve both sufficient low-temperature fixability and heat-resistant storage performance.

The glass transition temperature (Tg) may be measured using a differential scanning calorimetry system, for example, for example, Diamond DSC (manufactured b Perkin Elmer Corporation). Specifically, 3.0 mg of the sample is sealed in an aluminum pan, and the temperature is changed in the order of heating, cooling, and heating. In the first heating, the sample is heated from room temperature (25° C.), and in the second heating, the sample is heated from 0° C. to 200° C. at a rate of 10° C./min. The temperature is maintained at 200° C. for 5 minutes. On cooling, the temperature is lowered from 200° C. to 0° C. at a rate of 10° C./min. The temperature is maintained at 0° C. for 5 minutes. The shift of the baseline is observed in the measurement curve obtained during the second heating, and the maximum slope of the extension line of the baseline before the shift and the shifted part of the baseline are observed. The intersection of the extension line of the baseline before the shift and the tangent line indicating the maximum inclination of the shift portion of the baseline is defined as the glass transition point (Tg). An empty aluminum pan is used as a reference.

### (Hybrid Amorphous Polyester Resin)

The amorphous polyester resin contained in the toner particles of the present invention is preferably a hybrid crystalline polyester resin in which an amorphous polyester polymer segment and an amorphous polymer segment other than the amorphous polyester are chemically bonded, from the viewpoint of low-temperature fixability. It is particularly preferred that the amorphous polymer segment other than the amorphous polyester is a vinyl polymer segment containing a constituent unit derived from styrene.

The amorphous polyester polymer segment means a portion derived from an amorphous polyester resin. In other words, it means a molecular chain with the same chemical structure as the molecular chain that constitutes the amorphous polyester resin described above.

The content of the amorphous polyester polymer segment is preferably 50 to 99.9 mass % of the total amount of the hybrid amorphous polyester resin, and it is more preferably 70 to 95 mass %. By setting the content in the above range, low-temperature fixing may be achieved while maintaining heat resistance, and the advantage of balancing the affinity with the amorphous vinyl resin may be obtained.

Other matters (components, synthetic methods) of the hybrid amorphous polyester resin are the same as those of the hybrid crystalline polyester resin described above, except that the crystalline polyester polymer segment and the amorphous polyester polymer segment are different.

### <Amorphous Vinyl Resin>

An amorphous vinyl resin is a polymer of a monomer having a vinyl group (hereinafter referred to as vinyl monomers) that exhibits amorphous properties.

The vinyl resins that may be used include a styrene-acrylic resin, a styrene resin, and an acrylic resin. A styrene-acrylic resin is particularly preferred for its excellent heat resistance.

The vinyl monomers that may be used include the following, and one of these may be used alone or in combination with two or more others.

(1) Styrene monomers

Styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, n-nonylstyrene, p-n-decylstyrene, p-n-dodecylstyrene, and their derivatives

(2) (Meth)acrylic acid ester monomers

Methyl (meth)acrylate, ethyl (meth)acrylate, n-butyl (meth)acrylate, isopropyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, phenyl (meth)acrylate, diethylaminoethyl (meth)acrylate, dimethylaminoethyl (meth)acrylate and monomers having a (meth)acrylic group such as these derivatives

(3) Vinyl esters

Vinyl propionate, vinyl acetate, vinyl benzoate

(4) Vinyl ethers

Vinyl methyl ether, vinyl ethyl ether

(5) Vinyl ketones

Vinyl methyl ketone, vinyl ethyl ketone, vinyl hexyl ketone

(6) N-vinyl compounds

N-vinylcarbazole, N-vinylindole, N-vinylpyrrolidone

### (7) Others

Vinyl compounds such as vinyl naphthalene and vinyl pyridine; derivatives of acrylic acid and methacrylic acid such as acrylonitrile, methacrylonitrile, and acrylamide

As for vinyl monomers, it is preferable to use monomers with ionic dissociating groups such as a carboxy group, a sulfonic acid group, and a phosphoric acid group, because they facilitate the control of affinity with crystalline resins.

Examples of the monomer with a carboxy group include acrylic acid, methacrylic acid, maleic acid, itaconic acid, cinnamic acid, fumaric acid, maleic acid monoalkyl ester, and itaconic acid monoalkyl ester.

Examples of the monomer with a sulfonic acid group include styrenesulfonic acid, arylsulfosuccinic acid, and 2-acrylamide-2-methylpropanesulfonic acid.

Examples of the monomer having a phosphoric acid group include acid phosphooxyethyl methacrylate.

In addition, polyfunctional vinyls may be used as vinyl monomers to obtain polymers with a cross-linked structure.

Examples of the polyfunctional vinyl include divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, and neopentyl glycol diacrylate.

The preferred weight average molecular weight (Mw) and glass transition temperature (Tg) of amorphous vinyl resins are the same as those of the amorphous polyester resins described above.

### <Analytical Method of Resin Composition>

The composition of each resin contained in the toner particles may be analyzed by, for example, a combination of pyrolysis gas chromatography/mass spectrometry (GC/MS: Gas Chromatography/Mass Spectrometry).

Specifically, monomers with specific structures may be quantified by the standard addition method using columns and detectors that have been confirmed to be capable of detecting monomers with specific structures.

An example of the detailed pyrolysis conditions and GC/MS measurement conditions is shown below.

### (Pyrolysis Conditions)

Measuring equipment: PY-2020iD (Frontier Labs, Inc.)

Mass of measurement: 0.1 mg

Heating temperature: 550° C.

Heating time: 0.5 min.

### (GC/MS Measurement Conditions)

Measuring equipment: QP2010 (Shimadzu Corporation)

Column: UltraALLOY-5 (inner diameter: 0.25 mm, length: 30 m, thickness: 0.25 μm, Frontier Labs, Inc.)

Temperature rise range: 40° C. to 320° C. (held at 320° C.)

Temperature rise rate: 20° C./min.

### <<Mold Release Agent>>

The toner particles of the present invention are characterized by the inclusion of an ester wax as a mold release agent. This helps to suppress tacking. The toner particles of the present invention may also contain a release agent other than an ester wax, but it is preferable that the content of the ester wax is 20 mass % or more of the total content of the release agents. The total content of the mold release agent is preferably in the range of 3 to 15 mass % of the toner particles.

Ester waxes may be monoester waxes, diester waxes, triester waxes, tetraester waxes, and any wax with five or more ester bonds.

Examples of the ester wax include monoesterified products obtained by the reaction of higher fatty acids with higher alcohols, diesterified products obtained by the reaction of higher fatty acids with divalent alcohols or higher alcohols with divalent carboxylic acids, triesterified products obtained by the reaction of trimethylolpropane with higher fatty acids, triesterified products obtained by the reaction of glycerin with higher fatty acids, tetraesterified products obtained by the reaction of pentaerythritol with higher fatty acids, esterified products obtained by the reaction of hydroxy acids such as citric acid with higher fatty acids or higher alcohols. The examples contain esterified products obtained by reacting an aromatic carboxylic acid (such as malic acid) or alcohol with a higher fatty acid or higher alcohol.

The hydrocarbon chains of the above higher fatty acids and higher alcohols are preferably hydrocarbon chains with a carbon number between 13 and 30, and more preferably hydrocarbon chains with a carbon number between 17 and 22. The above divalent alcohols and divalent carboxylic acids have preferably two hydroxy groups or two carboxy groups at both ends of the hydrocarbon group with a carbon number of 13 to 30.

Each of the above hydrocarbon groups may be substituted with a linear or branched alkyl group, alkenyl group, alkynyl group, aromatic hydrocarbon ring group, aromatic heterocyclic group, non-aromatic hydrocarbon ring group, non-aromatic heterocyclic group, alkoxy group, cycloalkoxy group, aryloxy group, alkylthio group, cycloalkylthio group, arylthio group, alkoxycarbonyl group, aryloxycarbonyl group, sulfamoyl group, acyl group, acyloxy group, amide group, carbamoyl group, ureido group, sulfinyl group, alkylsulfonyl group, arylsulfonyl group or heteroarylsulfonyl group, amino group, halogen atom, fluorinated hydrocarbon group, cyano group, nitro group, hydroxy group, thiol group, silyl group, and deuterium atom.

Examples of the ester wax include behenyl behenate, triglycerol behenate, pentaerythritol tetrastearate, stearyl stearate, pentaerythritol tetrabehenate, ethylene glycol stearate, ethylene glycol behenate, neopentyl glycol stearate, neopentyl glycol behenate, 1,6-hexanediol stearate, 1,6-hexanediol behenate, glycerin stearate, glycerin behenate, stearyl citrate, behenyl citrate, stearyl malic acid ester, behenyl malic acid ester. Ester waxes may be natural waxes such as carnauba wax.

In addition, it is preferable that the toner particles of the present invention further contain a Fischer-Tropsch wax from the viewpoint of suppressing tacking. The Fischer-Tropsch wax is a hydrocarbon compound with a carbon number of 16 to 78 obtained from the distillation residue of hydrocarbons synthesized from synthesis gas consisting of carbon monoxide and hydrogen, or by hydrogenation to these hydrocarbons. The content of the Fischer-Tropsch wax is preferably in the range of 10 to 50 mass % of the total content of the mold release agent.

As other mold release agent, it may include, for example, low molecular weight polyethylene wax, low molecular weight polypropylene wax, microcrystalline wax, and paraffin wax.

### <<Colorant>>

As the colorant contained in the toner base particles of the present invention, any known inorganic or organic coloring agent may be used. In addition to carbon black and magnetic powder, various organic and inorganic pigments and dyes may be used as coloring agents. The content of the colorant is in the range of 1 to 20 mass %, preferably 2 to 10 mass %, of the toner particles.

### <<Charge Control Agent>>

As a charge control agent that may be contained in the toner particles according to the present invention, known compounds such as nigrosine-based dyes, metal salts of naphthenic acid or higher fatty acids, alkoxylated amines, quaternary ammonium salts, azo-based metal complexes, and salicylate metal salts may be used. The charge control agent may be used to obtain a toner with excellent charging characteristics. The content of the charge control agent is usually in the range of 0.1 to 5.0 parts by mass per 100 parts by mass of the binder resin.

<<External additive>>

The toner particles may be used as toner as they are, but it may be treated with an external additive such as a fluidizing agent or a cleaning aid in order to improve the fluidity, chargeability, and cleaning property.

Examples of the external additive include inorganic oxide particles such as silica particles, alumina particles, and titanium dioxide particles, inorganic stearic acid compound particles such as aluminum stearate particles and zinc stearate particles, and inorganic titanic acid compound particles such as strontium titanate and zinc titanate. These may be used alone or in combination of two or more types. From the viewpoint of improving heat-resistant storage and environmental stability, these inorganic particles are preferably gloss-treated with a silane coupling agent, a titanium coupling agent, a higher fatty acid, or a silicone oil.

The amount of external additive (total amount of external additives when multiple external additives are used) is preferably in the range of 0.05 to 5 parts by mass per 100 parts by mass of toner, and more preferably it is in the range of 0.1 to 3 parts by mass.

### <<Core-Shell Structure>>.

Toner particles may be used as toner as they are, but they may also be toner particles with a multilayer structure, such as a core-shell structure, in which the toner particles are core particles and the core particles have a shell layer covering their surface. The shell layer does not have to cover the entire surface of the core particles, and the core particles may be partially exposed. The cross-section of the core-shell structure may be confirmed by a known observation devices such as a transmission electron microscope (TEM: Transmission Electron Microscope) and a scanning probe microscope (SPM: Scanning Probe Microscope).

In the case of a core-shell structure, it is possible to differ the glass transition point, melting point, hardness, and other characteristics between the core particles and the shell layer, enabling the design of toner particles that meet the purpose. For example, on the surface of core particles containing a binder resin, a colorant, and a mold release agent, and having a relatively low glass transition point (Tg), a resin having a relatively high glass transition point (Tg) may be aggregated and fused to form a shell layer. The shell layer preferably contains an amorphous resin.

### <<Particle Size of Toner Particles>>

As for the average particle diameter of the toner particles, it is preferable that the median diameter (d₅₀) on a volume basis is in the range of 3 to 10 μm, and more preferably in the range of 5 to 8 μm. Within the above-described above range, high reproducibility may be obtained even for very small dot images at the 1200 dpi level. The average particle diameter of the toner particles may be controlled by the concentration of the coagulant used in manufacturing, the amount of organic solvent added, the fusion time, and the composition of the binder resin.

For the measurement of the median diameter (d₅₀) of toner particles on a volume basis, a measuring device in which a computer system equipped with the data processing software Software V3.51 is connected to Multisizer 3 (manufactured by Beckman Coulter) may be used.

Specifically, the sample to be measured (toner) is added to a surfactant solution (for example, a surfactant solution made by diluting neutral detergent containing surfactant ingredients in pure water 10 times for the purpose of dispersing toner particles), and then ultrasonic dispersion is performed to prepare a toner particle dispersion liquid. This toner particle dispersion liquid is placed in a beaker containing ISOTONII (manufactured by Beckman Coulter) in a sample stand. This concentration allows us to obtain reproducible measurement values. In the measurement system, the number of particles counted is set to 25,000, the aperture diameter is set to 100 μm. The frequency values are calculated by dividing the measurement range of 2 to 60 ₗam into 256 parts, and the particle diameter of the 50% from the larger volume integrated fraction is obtained as the median diameter (d₅₀) on a volume basis.

### <<Average Circularity of Toner Particles>>

The toner particles preferably have an average circularity in the range of 0.930 to 1.000, more preferably in the range of 0.950 to 0.995, from the viewpoint of enhancing the stability of charging characteristics and low-temperature fixability. When the average circularity is within the above range, individual toner particles are less likely to be crushed. This makes it possible to stabilize chargeability of the toner by suppressing contamination of the frictional charge-applying member, and to enhance the image quality of the formed image.

The average circularity of toner particles may be measured using FPIA-3000 (manufactured by Sysmex Corporation).

Specifically, the measurement sample (toner) is soaked in an aqueous solution containing surfactant and dispersed by ultrasonic dispersion for 1 minute. After that, the sample was dispersed by FPIA-3000 (Sysmex Corporation) in the HPF (high magnification imaging) mode, with the number of HPF detections between 3000 and 10000. When the number of HPF detections is within the above range, reproducible measurement values may be obtained. From the photographed particle images, calculate the circularity of each toner particle according to the following Formula (I), and then add the circularity of each toner particle and divide by the total number of toner particles to obtain the average circularity.

Circularity=(Circumference of a circle having the same projected area as the particle image)/(Circumference of the particle projection image) Formula (I)

### <<Production Method of Electrostatic Charge Image Developing Toner>>

The manufacturing method of the electrostatic charge image developing toner of the present invention is not limited to any particular method, but includes known methods such as kneading and pulverizing method, suspension polymerization, emulsion aggregation method, dissolution suspension method, polyester elongation method, and dispersion polymerization method. Among these methods, the emulsion aggregation method is preferable from the viewpoint of uniformity of particle diameter and control of shape.

### <Emulsion Aggregation Method>

The emulsion aggregation method is a method in which a dispersion liquid of binder resin particles (hereinafter, also referred to as “binder resin particles”) dispersed by a surfactant or a dispersion stabilizer is mixed with a dispersion of colorant particles (hereinafter, also referred to as “colorant particles”), aggregated until the desired toner particle size is obtained, and further fused between the binder resin particles. Toner particles are manufactured by controlling the shape of the toner particles. Here, the particles of the binder resin contain an ester wax, other mold release agents, and charge control agents as necessary. An example of a preferred manufacturing method for the toner of the present invention, where the emulsion aggregation method is used to obtain toner particles with a core-shell structure, is shown below.

(1) Step of preparing a colorant particle dispersion liquid in which colorant particles are dispersed in an aqueous medium
(2) Step of preparing a resin particle dispersion liquid (resin particle dispersion liquid for core/shell) in which binding resin particles containing internal additives (e.g., a mold release agent) are dispersed as necessary in an aqueous medium
(3) Step of mixing the colorant particle dispersion liquid and the core resin particle dispersion are mixed to obtain an aggregating resin particle dispersion liquid, and the colorant particles and the binder resin particles are aggregated and fused in the presence of the aggregating agent to obtain the core particles (aggregation and fusion step)
(4) Step of forming toner base particles with a core-shell structure by adding a dispersion liquid of resin particles for shells containing binder resin particles for the shell layer to a dispersion liquid containing core particles, and aggregating and fixing the particles for the shell layer on the surface of the core particles (aggregation and fusion step)
(5) Step of filtering the toner base particles from the dispersion liquid of toner base particles (toner base particle dispersion liquid) and removing surfactants (washing step)
(6) Step of drying toner base particles (drying step)
(7) Step of adding an external additive to the toner base particles (external additive treatment step)

Toner particles with a core-shell structure may be obtained as follows. First, the binder resin particles for the core particles and the colorant particles are aggregated and fused to prepare the core particles. Next, the binder resin particles for the shell layer are added to the dispersion liquid of the core particles, and the binder resin particles for the shell layer are aggregated and fused on the surface of the core particles to form a shell layer covering the surface of the core particles.

However, for example, in the above step (4), toner particles formed from single-layer particles may be similarly produced without adding the resin particle dispersion liquid for shell.

### <External Additive Processing>

The external additive mixing process for toner base particles may be done using mechanical mixing equipment. As mechanical mixing devices, a Henschel mixer, a Nauta mixer, and a turbulence mixer may be used. Among these, a mixing device that can impart shearing force to the particles being processed, such as a Henschel mixer, may be used with increasing the mixing time or increasing the rotational peripheral speed of the agitator blades. When multiple types of external additives are used, the toner base particles may be mixed and treated with all the external additives at once or divided and mixed multiple times depending on the external additives.

The degree of cracking and adhesion strength of the external additive may be adjusted by controlling the mixing strength, i.e., the peripheral speed of the agitator blades, mixing time, and mixing temperature, using the mechanical mixing device described above.

### <<Electrostatic Charge Image Developer>>

The electrostatic charge image developing toner of the present invention may be used as a magnetic or non-magnetic single-component electrostatic charge image developer. It may also be mixed with a carrier to be used as a two-component electrostatic charge image developer. When the toner is used as a two-component electrostatic charge image developer, magnetic particles made of conventionally known materials such as iron, ferrite, magnetite and other metals, and alloys of such metals with aluminum, lead and other metals may be used as carriers, with ferrite particles being particularly preferred.

The carrier may be a coated carrier in which the surface of the magnetic particles is coated with a resin or other coating agent, or a dispersed carrier in which the magnetic fine powder is dispersed in a binder resin.

The median diameter (d₅₀) of the carrier on a volume basis is preferably in the range of 20 to 100 μm, and it is more preferable to be in the range of 25 to 80 μm.

The volume-based median diameter (d₅₀) of the carrier may be measured using, for example, a laser diffraction particle size analyzer equipped with a wet disperser (HELOS) (manufactured by SYMPATEC Gmbh).

### EXAMPLES

The present invention is not limited to the following examples, although the invention will be described in detail in the following. In the examples, “part” or “%” is used to indicate “part by mass” or “mass %” unless otherwise specified.

### <Preparation of Colorant Particle Dispersion Liquid (Cyan)>

A solution prepared by adding 90 parts by mass of sodium dodecyl sulfate to 1600 parts by mass of ion-exchanged water was stirred, and 420 parts by mass of “CA. Pigment Blue 15:3” was gradually added as a colorant. The colorant particle dispersion liquid was prepared by using an agitator CLEARMIX (manufactured by M Technique Co., Ltd. “CLEARMIX” is a registered trademark of the company) to perform the dispersion process.

The colorant particles in the dispersion liquid had a median diameter of 110 nm on a volume basis. The median diameter of the colorant particles on a volume basis was measured using the UPA-150 micro-track particle size analyzer (Nikkiso Co., Ltd.). In the following examples, the particle diameter of each particle was measured in the same way.

### <Synthesis of Crystalline Polyester Resin 1 (CP1)>

The following raw monomers for a styrene-acrylic polymer segment, an amphoteric compound, and a radical polymerization initiator were placed in a dropping funnel.

Styrene: 36 parts by mass

n-Butyl acrylate: 13 parts by mass

Acrylic acid (amphoteric compound): 2 parts by mass

Di-t-butyl peroxide radical (polymerization initiator): 7 parts by mass

The following raw material monomers for a crystalline polyester polymer segment were placed in a four-necked flask equipped with a nitrogen gas introduction tube, a dehydration tube, a stirrer, and a thermocouple, and heated to 170° C. to dissolve.

Sebacic acid: 344 parts by mass

1,10-Decanediol: 296 parts by mass

Then, the raw materials in the dropping funnel were dropped into the four-necked flask over 90 minutes under stirring. After that, the product was aged for 60 minutes, and the unreacted monomer was removed under reduced pressure (8 kPa). The amount of the monomers removed at this time was a very small amount compared to the amount of monomers in the above preparation.

Then, 0.8 parts of mass of titanium tetrabutoxide (Ti(O-n-Bu)₄) was added as an esterification catalyst, and the temperature was raised to 235° C. The reaction was carried out at ambient pressure (101.3 kPa) for 5 hours, and then at reduced pressure (8 kPa) for 1 hour.

Then, it was cooled down to 200° C. and reacted under reduced pressure (20 kPa) for another 1 hour. Then, a crystalline polyester resin 1 (CP1) which is a hybrid crystalline polyester resin was obtained by removing the solvent.

The crystalline polyester resin 1 (CP1) has a weight average molecular weight of 21600, a melting point of 77° C., and an acid value of 18 mg KOH/g.

### <Synthesis of Crystalline Polyester Resins 2 to 13 (CP2 to CP13>

In the synthesis of crystalline polyester resin 1 (CP1), the types and amounts of dicarboxylic acid monomer and dialcohol monomer were changed as shown in Table I. Crystalline polyester resins 2 to 13 (CP2 to CP 13) were thus obtained.

The weight average molecular weights, melting points, and acid values of the crystalline polyester resins 2 to 13 (CP2 to CP13) are listed in Table 1.

### <Preparation of Crystalline Polyester Resin Particle Dispersion Liquid>

100 parts by mass of each of the crystalline polyester resins synthesized above were dissolved in 400 parts by mass of ethyl acetate. The mixture was mixed with 638 parts by mass of 0.26 mass % sodium dodecyl sulfate solution. While stirring the obtained mixed solution, an ultrasonic homogenizer US-150T (manufactured by Nissei Corporation) was used to perform ultrasonic dispersion treatment with V-LEVEL 300 ILEA for 30 minutes.

Then, with the temperature heated to 40 ° C., ethyl acetate was completely removed while stirring for 3 hours under reduced pressure using a diaphragm vacuum pump V-700 (manufactured by BUCHI Corporation). A dispersion liquid of each crystalline polyester resin particle with a solid content of 13.5 mass % was obtained.

The crystalline polyester resin particles in the dispersion liquid had a median diameter of 160 nm on a volume basis.

### <Synthesis of Amorphous Polyester Resin 1 (AP1)>

The following raw monomers for a styrene-acrylic polymer segment, an amphoteric compound, and a radical polymerization initiator were placed in a dropping funnel.

Styrene: 80 parts by mass

n-Butyl acrylate: 20 parts by mass

Acrylic acid (amphoteric compound): 10 parts by mass

Di-t-Butyl peroxide radical (polymerization initiator): 16 parts by mass

The following raw monomers for an amorphous polyester polymer segment were placed in a four-necked flask equipped with a nitrogen gas inlet tube, a dehydration tube, a stirrer, and a thermocouple, and heated to 170° C. to dissolve.

Bisphenol A propylene oxide 2-mol adduct: 284.3 parts by mass

1,10-Decanediol: 0.7 parts by mass

Terephthalic acid: 66.2 parts by mass

Fumaric acid: 47.4 parts by mass

Sebacic acid: 0.8 parts by mass

Then, the raw material in the dropping funnel was dropped into the four-necked flask over 90 minutes under stirring. After that, the product was aged for 60 minutes, and the unreacted monomer was removed under reduced pressure (8 kPa). The amount of monomers removed at this time was a very small amount compared to the amount of monomers in the above preparation.

Then, 0.4 parts by mass of titanium tetrabutoxide (Ti(O-n-Bu)₄) was added as an esterification catalyst, and the temperature was raised to 235° C. The reaction was carried out at ambient pressure (101.3 kPa) for 5 hours, and then at reduced pressure (8 kPa) for 1 hour.

Then, the reaction mixture was cooled to 200° C. and the reaction was further carried out under reduced pressure (20 kPa) for 1 hour. Then, the solvent was removed to obtain an amorphous polyester resin 1 (API), which is a hybrid amorphous polyester resin.

The amorphous polyester resin 1 (API) had a weight average molecular weight of 25000, and its glass transition point was 60° C.

### <Synthesis of Amorphous Polyester Resins 2 to 9 (AP2 to AP9)>

In the synthesis of amorphous polyester resin 1 (API), the types and amounts of dicarboxylic acid monomer and dialcohol monomer were changed as described in Table II. Amorphous polyester resins 2 to 9 (AP2 to AP9) were obtained in the same manner.

The weight average molecular weights of amorphous polyester resins 2 to 9 (AP2 to AP9) and their glass transition temperature are as listed in Table 2.

### <Preparation of Amorphous Polyester Resin Particle Dispersion Liquid>

100 parts by mass of each of the amorphous polyester resins synthesized above were dissolved in 400 parts by mass of ethyl acetate. The mixture was mixed with 638 parts by mass of 0.26 mass % sodium dodecyl sulfate solution. While stirring the obtained mixed solution, an ultrasonic homogenizer US-150T (manufactured by Nissei Corporation) was used to perform ultrasonic dispersion treatment with V-LEVEL 300 μA for 30 minutes.

Then, with the temperature heated to 40° C., ethyl acetate was completely removed while stirring for 3 hours under reduced pressure using a diaphragm vacuum pump V-700 (manufactured by BUCHI Corporation). A dispersion liquid of each amorphous polyester resin particle with a solid content of 13.5 mass % was obtained.

The amorphous polyester resin particles in the dispersion liquid had a median diameter of 160 nm on a volume basis.

### <Preparation of Amorphous Vinyl Resin (SP1) Particle Dispersion Liquid>

### (First Stage Polymerization)

8 parts by mass of sodium dodecyl sulfate and 3000 parts by mass of ion-exchanged water were placed in a 5L reaction vessel equipped with a stirrer, a temperature sensor, a cooling pipe, and a nitrogen inductor. The internal temperature was raised to 80° C. while stirring the mixture at 230 rpm under a nitrogen flow. After the temperature was raised, a solution prepared by dissolving 10 parts by mass of potassium persulfate in 200 parts by mass of ion-exchanged water was added, the liquid temperature was set to 80° C. again, and a mixed solution of the following monomers was added dropwise over 1 hour.

Styrene: 570 parts by mass

n-Butyl acrylate: 165 parts by mass

Methacrylic acid: 68 parts by mass

After dropping the above mixture, polymerization was carried out by heating and stirring at 80° C. for 2 hours to prepare an amorphous vinyl resin particle dispersion liquid (1-a).

### (Second Stage Polymerization)

A solution prepared by dissolving 3 parts by mass of sodium polyoxyethylene (2) dodecyl ether sulfate in 1210 parts by mass of ion-exchanged water (10 parts by mass) was placed in a reaction vessel equipped with a stirrer, a temperature sensor, a cooling pipe, and a nitrogen inductor. The mixture was heated to 80° C. After heating, 60 parts by mass of the amorphous vinyl resin particle dispersion liquid (1-a) prepared by the first-stage polymerization and a mixture solution of the following monomers, a chain transfer agent and a mold release agent dissolved at 80° C. was added.

Styrene: 245 parts by mass

2-Ethylhexyl acrylate: 97 parts by mass

Methacrylic acid: 30 parts by mass

n-Octyl-3-mercaptopropionate: 4 parts by mass

Behenyl behenate: 170 parts by mass

The melting point of behenyl behenate used as the mold release agent above is 73° C.

A dispersion liquid containing emulsified particles (oil droplets) was prepared by performing a mixing and dispersion treatment for 1 hour using a stirring device CLEARMIX (manufactured by M Technique Co., Ltd., “CLEARNIIX” is a registered trademark of the same company) having a circulation path. To this dispersion, a solution of polymerization initiator containing 5.2 parts by mass of potassium persulfate dissolved in 200 parts by mass of ion-exchanged water and 1000 parts by mass of ion-exchanged water were added. The polymerization was carried out by heating and stirring the system at 84° C. for 1 hour to prepare an amorphous vinyl resin particle dispersion liquid (1-b).

### (Third Stage Polymerization)

To the amorphous vinyl resin particle dispersion liquid (1-b) obtained by the above second stage polymerization, a solution prepared by dissolving 7 parts by mass of potassium persulfate in 130 parts by mass of ion-exchanged water was added. Furthermore, a mixture of the following monomers and a chain transfer agents was added dropwise over a period of one hour under the temperature condition of 82° C.

Styrene: 350 parts by mass

Methyl methacrylate: 50 parts by mass

n-Butyl acrylate: 170 parts by mass

Methacrylic acid: 35 parts by mass

n-Octyl-3-mercaptopropionate: 8 parts by mass

After completion of the dropping, the polymerization was carried out by heating and stirring for 2 hours, and then cooled to 28° C. to obtain a dispersion liquid of amorphous vinyl resin 1 (SP1) particles.

The amorphous vinyl resin 1 (SP1) particles in the dispersion liquid had a median diameter of 145 nm on a volume basis. The weight average molecular weight of the obtained amorphous vinyl resin 1 (SP1) was 35000, and the glass transition point was 37° C.

In the preparation of the amorphous vinyl resin 1 (SP1) particle dispersion liquid, the type and amount of the release agent used in the second stage polymerization were changed as follows to obtain an amorphous vinyl resin 2 (SP2) particle dispersion liquid.

Behenyl behenate: 136 parts by mass

Fischer-Tropsch wax: 34 parts by mass

The melting points of behenyl behenate and Fischer-Tropsch wax used as mold release agents above are 73° C. and 90° C., respectively.

### <Production of Toner No.1>

In a reaction vessel equipped with a stirrer, a temperature sensor, and a cooling pipe, 527 parts by mass of the amorphous vinyl resin (SP1) particle dispersion liquid prepared above, 33 parts by mass of the colorant particle dispersion liquid (solid content equivalent), and 500 parts by mass of ion-exchanged water were added. 5 mol/L of aqueous sodium hydroxide solution was added to adjust the pH to 10. In addition, a solution of 60.8 parts by mass of magnesium chloride hexahydrate diluted 2 times with ion-exchanged water was added over 10 minutes at 30° C. while stirring. After standing for 3 minutes, the temperature was raised to 80° C. over a period of 60 minutes. After reaching 80° C., a solution of 10 parts by mass of magnesium chloride hexahydrate diluted 2 times with ion-exchange water was added over 10 minutes at 30° C. with stirring, and left for 5 minutes.

Then, a mixed dispersion of the following components was added to the above mixed dispersion over a period of 30 minutes. The following parts by mass are converted to solid content.

Crystalline polyester resin 1 (CP1) particle dispersion liquid: 35 parts by mass Crystalline polyester resin 2 (CP2) particle dispersion liquid: 35 parts by mass Dodecyl diphenyl ether disulfonic acid sodium salt: 10 parts by mass

When the supernatant of the reaction solution became transparent, the stirring speed was adjusted so that the growth rate of the particle size was 0.02 μm/min. When the volume-based median diameter measured by Coulter Multisizer 3 (manufactured by Beckman Coulter) reached 5.8 !μm, the stirring speed was adjusted to stop the particle size growth.

Then, 70 mass (solid content equivalent) of amorphous polyester resin (API) particle dispersion liquid was added over a period of 30 minutes. When the supernatant of the reaction solution became transparent, an aqueous solution prepared by dissolving 80 mass of sodium chloride in 320 mass of ion-exchanged water was added to stop the growth of the particle size.

Then, the temperature was raised and stirred at 80° C., and the flow particle image analyzer “FPIA-3000” (Sysmex Corporation) was used. When the average circularity of the toner base particles reaches 0.97%, the reaction solution was cooled to 25° C. at a cooling rate of 10° C./min to obtain a dispersion liquid of the toner base particles.

Then, solid-liquid separation was performed, and the dehydrated cake of toner base particles was washed by re-dispersing it in ion-exchange water and repeating the solid-liquid separation operation three times. After washing, the toner base particles were dried at 35° C. for 24 hours to obtain the toner base particles.

To 100 parts by mass of the toner base particles obtained, 0.6 parts by mass of hydrophobic silica particles (number average primary particle size: 12 nm, degree of hydrophobicity: 68), 1.0 part by mass of hydrophobic titanium dioxide particles (number average primary particle size: 20 nm, hydrophobicity: 63), and 1.0 part by mass of sol-gel silica (number average primary particle size: 110 nm, hydrophobicity: 63) were added, and the mixture was mixed with a Henschel mixer (Japan Coke & Engineering Co., Ltd.) at a rotor blade speed of 40 msec. After mixing, coarse particles were removed using a sieve with an opening of 45 μm to obtain toner No. 1.

The obtained toner No. 1 had toner particle with a volume-based median diameter of 5.9 !μm.

### <Production of Toners No.2 to No.29>

In the production of toner No. 1, the types and amounts of amorphous vinyl resin particle dispersion liquid, amorphous polyester resin particle dispersion liquid, and crystalline polyester resin particle dispersion liquid were changed as listed in Table III, respectively. Thus, toners No.2 to No.29 were obtained.

### <Production of Developer Nos. 1 to 29>

The toner produced above and a ferrite carrier with a volume average particle diameter of 32 μm coated with acrylic resin were added and mixed to achieve a toner concentration of 6 mass %. Thus, developer No. 1 to 29, which are two-component developers containing toners No. 1 to 29 respectively, were produced.

### <Evaluation of Low-Temperature Fixing Property>

The fixing device of a multifunction printer “bizhub PRESS™ C1070” (manufactured by Konica Minolta, Inc.) was modified so that the surface temperatures of the fixing upper belt and the fixing lower roller may be changed, and the two-component developer was sequentially loaded. The above device was modified so that the fixing temperature, toner adhesion amount, and system speed may be freely set. In an environment of normal temperature and humidity (temperature: 20° C., humidity: 50% RH) the adhesion amount was set to be 11.3 g/m² on A4 size fine paper “NPI Fine Paper (127.9 g/m²)” (Nippon Paper Industries Co.). After that, a fixing experiment for fixing an image having a size of 100 mm×100 mm was repeated from 110° C. to 180° C. while changing the set fixing temperature in increments of 2° C. The lowest fixing temperature at which image contamination due to fixing offset cannot be visually confirmed was set as the lowest fixing temperature (U.O. avoidance temperature). Then, the low temperature fixing property was evaluated according to the following evaluation criteria. The evaluation results are shown in Table IV.

### (Evaluation Criteria)

AA: Lowest fixing temperature is less than 135° C. (excellent toner with excellent low-temperature fixability).

BB: Lowest fixing temperature is 135° C. or more and less than 140° C. (no practical problem).

CC: Lowest fixing temperature is 140° C. or more (the target paper passing speed is not sufficiently established, and there is a practical problem).

### <Evaluation of Tacking>

The fixing device of a multifunction device “bizhub PRESS' C1070” (manufactured by Konica Minolta, Inc.) was modified so that the surface temperature of the fixing upper belt and the fixing lower roller may be changed, and the two-component developer was sequentially loaded.

The above device was modified so that the fixing temperature, toner adhesion amount, system speed, and paper ejection air may be freely set. In an environment of normal temperature and humidity (temperature: 20° C., humidity: 50%RH), the fixing experiment was conducted using an A4-size coated paper “OK Top Coat+(157.0 g/m²)” (manufactured by Oji Paper Co., Ltd.). The fixing experiment was performed on 800 sheets at a fixing temperature of 180° C.

In order to record the paper surface temperature, the thermocouple “molded surface sensor: MF-OK” (TOA Equipment) was attached to the center of 1, 100, 200, 300, 400, 500, 600, and 700th images of the ejected images. After all 800 fused images were loaded in the paper exit tray, the paper was left for 8 hours until the paper temperature cooled down. The maximum temperature reached between the time the paper was discharged and the time it cooled down was used as the measured temperature of the paper.

The 1, 100, 200, 300, 400, 500, 600, and 700th images were evaluated to see how much the superimposed images were attached to each other after being left for 8 hours.

The measured temperature in the image that reached an OK level according to the following evaluation criteria was defined as the tacking elimination temperature. The measured temperature may be controlled by changing the air flow rate of the ejection air. When NG is detected in all of 1st, 100th, 200th, 300th, 400th, 500th, 600th, and 700th images, the air volume of the ejection air was increased, and the same experiment was repeated until an OK level image was obtained.

### (Evaluation Criteria)

OK: May be easily peeled off by hand and the toner image surface is not rough.

NG: The toner image surface is rough after peeling off.

The tacking elimination temperature is shown in Table IV. The higher the tacking elimination temperature, the more difficult it is for the toner to produce tacking, and a temperature of 56° C. or higher is considered to be acceptable.

TABLE I

| | | Number of | | | | | | | |
|---|---|---|---|---|---|---|---|---|---|
| | | carbon | Number of parts by mass | | | | | | |
| | | atoms | CP1 | CP2 | CP3 | CP4 | CP5 | CP6 | CP7 |
| Polyvalent | 1,4-Butanediol | 4 | — | 153 | — | — | — | — | — |
| alcohol | 1,6-Hexanediol | 6 | — | — | — | — | — | — | — |
| monomer | 1,9-Nonanediol | 9 | — | — | — | — | — | 272 | — |
| | 1,10-Decanediol | 10 | 296 | — | 296 | 296 | 296 | — | — |
| | 1,12-Dodecanediol | 12 | — | — | — | — | — | — | 344 |
| | 1,14-Tetradecanediol | 14 | — | — | — | — | — | — | — |
| Polyvalent | Azelaic acid | 9 | — | — | — | — | — | — | — |
| carboxy | Sebacic acid | 10 | 344 | — | 346 | 350 | 354 | 344 | 344 |
| acid | Dodecanedioic | 12 | — | — | — | — | — | — | — |
| monomer | acid | | | | | | | | |
| | Tetradecanedioic | 14 | — | 440 | — | — | — | — | — |
| | acid | | | | | | | | |

| | | | | | | | |
|---|---|---|---|---|---|---|---|
| Melting point [° C.] | 77 | 76 | 77 | 77 | 77 | 68 | 77 |
| Acid value [mg KOH/g] | 18 | 18 | 22 | 26 | 30 | 22 | 22 |
| Weight average molecular weight | 21600 | 24500 | 21000 | 22000 | 21000 | 27000 | 22000 |

| | | Number of | | | | | | |
|---|---|---|---|---|---|---|---|---|
| | | carbon | Number of parts by mass | | | | | |
| | | atoms | CP8 | CP9 | CP10 | CP11 | CP12 | CP13 |
| Polyvalent | 1,4-Butanediol | 4 | — | — | — | — | — | — |
| alcohol | 1,6-Hexanediol | 6 | — | — | — | 201 | — | — |
| monomer | 1,9-Nonanediol | 9 | — | — | — | — | 272 | — |
| | 1,10-Decanediol | 10 | 296 | 296 | — | — | — | — |
| | 1,12-Dodecanediol | 12 | — | — | 344 | — | — | — |
| | 1,14-Tetradecanediol | 14 | — | — | — | — | — | 391 |
| Polyvalent | Azelaic acid | 9 | — | — | — | — | 321 | — |
| carboxy | Sebacic acid | 10 | — | — | — | — | — | 344 |
| acid | Dodecanedioic | 12 | 392 | — | 392 | — | — | — |
| monomer | acid | | | | | | | |
| | Tetradecanedioic | 14 | — | 440 | — | 440 | — | — |
| | acid | | | | | | | |

| | | | | | | |
|---|---|---|---|---|---|---|
| Melting point [° C.] | 77 | 81 | 82 | 78 | 65 | 80 |
| Acid value [mg KOH/g] | 22 | 22 | 22 | 22 | 22 | 22 |
| Weight average molecular weight | 24500 | 23000 | 20600 | 23100 | 23000 | 20500 |

TABLE II
Amorphous polyester resin

| | Polyvalent carboxy acid monomer | | | | | | | |
|---|---|---|---|---|---|---|---|---|
| | Terephthalic | Fumaric | Sebacic | | Tetradecanedioic | | Polyvalent alcohol monomer | |
| | acid | acid | acid | | acid | | BPA | 1,9-Nonanediol |
| | [Parts by | [Parts by | [Parts by | | [Parts by | | [Parts by | [Parts by |
| No. | mass] | mass] | mass] | [mol %] | mass] | [mol %] | mass] | mass] |
| AP1 | 66.2 | 47.4 | 0.8 | 0.5 | — | — | 284.3 | — |
| AP2 | 65.6 | 47.4 | 1.6 | 1 | — | — | 282.8 | — |
| AP3 | 64.2 | 47.4 | 3.3 | 2 | — | — | 280.0 | — |
| AP4 | 61.5 | 47.4 | 6.6 | 4 | — | — | 274.3 | — |
| AP5 | 56.1 | 47.4 | 13.1 | 8 | — | — | 262.8 | — |
| AP6 | 45.3 | 47.4 | 26.2 | 16 | — | — | 240.0 | — |
| AP7 | 66.9 | 47.4 | — | — | — | — | 285.7 | — |
| AP8 | 66.9 | 47.4 | — | — | — | — | 262.8 | 10.6 |
| AP9 | 56.1 | 47.4 | — | — | 16.8 | 8 | 285.7 | — |

| | Polyvalent alcohol monomer | | | | Weight | Glass |
|---|---|---|---|---|---|---|
| | | 1,10-Decanediol | | C9 to C14 | average | transition |
| | 1,9-Nonanediol | [Parts by | | components | molecular | point |
| No. | [mol %] | mass] | [mol %] | [mol %] | weight | [° C.] |
| AP1 | — | 0.7 | 0.5 | 1 | 25000 | 60 |
| AP2 | — | 1.4 | 1 | 2 | 25400 | 60 |
| AP3 | — | 2.9 | 2 | 4 | 26200 | 60 |
| AP4 | — | 5.8 | 4 | 8 | 29400 | 60 |
| AP5 | — | 11.6 | 8 | 16 | 31300 | 60 |
| AP6 | — | 23.1 | 16 | 32 | 33200 | 60 |
| AP7 | — | — | — | 0 | 25000 | 60 |
| AP8 | 8 | — | — | 8 | 32000 | 60 |
| AP9 | — | — | — | 8 | 30600 | 60 |

BPA: Bisphenol A propylene oxide 2-mol adduct
C9 to C14 components [mol %]: Total of the constituting components derived from linear dicarboxylic acid or linear dialcohol having a number of carbon atoms in the range of 9 to 14.

TABLE III

| | Amorphous vinyl | | | | | | Amorphous polyester | | | |
|---|---|---|---|---|---|---|---|---|---|---|
| | resin | | Crystalline polyester resin | | | | resin | | | |
| | | [Parts by | | [Parts by | | [Parts by | | [Parts by | Ratio of | |
| | No. | mass] | No. | mass] | No. | mass] | No. | mass] | Wap/Wcp | Remarks |
| Toner No. 1 | SP1 | 527 | CP1 | 35 | CP2 | 35 | AP1 | 70 | 1 | Present Invention |
| Toner No. 2 | SP1 | 527 | CP1 | 49 | CP2 | 21 | AP1 | 70 | 1 | Present Invention |
| Toner No. 3 | SP1 | 527 | CP1 | 63 | CP2 | 7 | AP1 | 70 | 1 | Present Invention |
| Toner No. 4 | SP1 | 527 | CP1 | 70 | — | — | AP1 | 70 | 1 | Present Invention |
| Toner No. 5 | SP2 | 527 | CP1 | 70 | — | — | AP1 | 70 | 1 | Present Invention |
| Toner No. 6 | SP2 | 527 | CP1 | 70 | — | — | AP2 | 70 | 1 | Present Invention |
| Toner No. 7 | SP2 | 527 | CP1 | 70 | — | — | AP3 | 70 | 1 | Present Invention |
| Toner No. 8 | SP2 | 527 | CP1 | 70 | — | — | AP4 | 70 | 1 | Present Invention |
| Toner No. 9 | SP2 | 527 | CP1 | 70 | — | — | AP5 | 70 | 1 | Present Invention |
| Toner No. 10 | SP2 | 527 | CP1 | 70 | — | — | AP6 | 70 | 1 | Present Invention |
| Toner No. 11 | SP2 | 527 | CP1 | 70 | — | — | AP7 | 70 | 1 | Comparative Example |
| Toner No. 12 | SP2 | 527 | CP1 | 70 | — | — | AP8 | 70 | 1 | Present Invention |
| Toner No. 13 | SP2 | 527 | CP1 | 70 | — | — | AP9 | 70 | 1 | Present Invention |
| Toner No. 14 | SP2 | 527 | CP3 | 70 | — | — | AP4 | 70 | 1 | Present Invention |
| Toner No. 15 | SP2 | 527 | CP4 | 70 | — | — | AP4 | 70 | 1 | Present Invention |
| Toner No. 16 | SP2 | 527 | CP5 | 70 | — | — | AP4 | 70 | 1 | Present Invention |
| Toner No. 17 | SP2 | 527 | CP6 | 70 | — | — | AP4 | 70 | 1 | Present Invention |
| Toner No. 18 | SP2 | 527 | CP7 | 70 | — | — | AP4 | 70 | 1 | Present Invention |
| Toner No. 19 | SP2 | 527 | CP8 | 70 | — | — | AP4 | 70 | 1 | Present Invention |
| Toner No. 20 | SP2 | 527 | CP9 | 70 | — | — | AP4 | 70 | 1 | Present Invention |
| Toner No. 21 | SP2 | 527 | CP10 | 70 | — | — | AP4 | 70 | 1 | Present Invention |
| Toner No. 22 | SP2 | 527 | CP12 | 70 | — | — | AP4 | 70 | 1 | Present Invention |
| Toner No. 23 | SP2 | 527 | CP13 | 70 | — | — | AP4 | 70 | 1 | Present Invention |
| Toner No. 24 | SP2 | 527 | CP2 | 70 | — | — | AP4 | 70 | 1 | Comparative Example |
| Toner No. 25 | SP2 | 527 | CP11 | 70 | — | — | AP4 | 70 | 1 | Comparative Example |
| Toner No. 26 | SP2 | 590 | CP3 | 70 | — | — | AP4 | 7 | 0.1 | Present Invention |
| Toner No. 27 | SP2 | 562 | CP3 | 70 | — | — | AP4 | 35 | 0.5 | Present Invention |
| Toner No. 28 | SP2 | 492 | CP3 | 70 | — | — | AP4 | 105 | 1.5 | Present Invention |
| Toner No. 29 | SP2 | 457 | CP3 | 70 | — | — | AP4 | 140 | 2 | Present Invention |

TABLE IV

| | Low- | Tacking | |
|---|---|---|---|
| | temperature | elimination | |
| | fixability | temperature | Remarks |
| Toner No. 1 | AA | 57° C. | Present Invention |
| Toner No. 2 | AA | 56° C. | Present Invention |
| Toner No. 3 | AA | 57° C. | Present Invention |
| Toner No. 4 | AA | 58° C. | Present Invention |
| Toner No. 5 | BB | 60° C. | Present Invention |
| Toner No. 6 | BB | 60° C. | Present Invention |
| Toner No. 7 | AA | 60° C. | Present Invention |
| Toner No. 8 | AA | 61° C. | Present Invention |
| Toner No. 9 | AA | 62° C. | Present Invention |
| Toner No. 10 | AA | 59° C. | Present Invention |
| Toner No. 11 | CC | Less than 56° C. | Comparative Example |
| Toner No. 12 | AA | 62° C. | Present Invention |
| Toner No. 13 | AA | 62° C. | Present Invention |
| Toner No. 14 | AA | 63° C. | Present Invention |
| Toner No. 15 | AA | 63° C. | Present Invention |
| Toner No. 16 | AA | 62° C. | Present Invention |
| Toner No. 17 | AA | 61° C. | Present Invention |
| Toner No. 18 | AA | 61° C. | Present Invention |
| Toner No. 19 | AA | 61° C. | Present Invention |
| Toner No. 20 | BB | 61° C. | Present Invention |
| Toner No. 21 | BB | 62° C. | Present Invention |
| Toner No. 22 | AA | 62° C. | Present Invention |
| Toner No. 23 | BB | 61° C. | Present Invention |
| Toner No. 24 | AA | Less than 56° C. | Comparative Example |
| Toner No. 25 | AA | Less than 56° C. | Comparative Example |
| Toner No. 26 | AA | 62° C. | Present Invention |
| Toner No. 27 | AA | 63° C. | Present Invention |
| Toner No. 28 | AA | 63° C. | Present Invention |
| Toner No. 29 | AA | 62° C. | Present Invention |

As shown in the above results, the toner of the present invention is superior to the toner of the comparative example in terms of low-temperature fixability and suppression of tacking.

Although embodiments of the present invention have been described and illustrated in detail, the disclosed embodiments are made for purposes of illustration and example only and not limitation. The scope of the present invention should be interpreted by terms of the appended claims.

What is claimed is:

1. An electrostatic charge image developing toner comprising at least toner particles, wherein the toner particles contain an amorphous vinyl resin, an amorphous polyester resin, a crystalline polyester resin, and an ester wax;
the crystalline polyester resin is a crystalline polyester resin obtained by polycondensation of a dicarboxylic acid having a number of carbon atoms in the range of 9 to 14 and a dialcohol having a number of carbon atoms in the range of 9 to 14;
the amorphous polyester resin is an amorphous polyester resin containing a constituent unit derived from a dicarboxylic acid having a number of carbon atoms in the range of 9 to 14 or a dialcohol having a number of carbon atoms in the range of 9 to 14; and
a sum of the number of carbon atoms of the dicarboxylic acid and the number of carbon atoms of the dialcohol is in the range of 18 to 24.

2. The electrostatic charge image developing toner according to claim 1, wherein among the total amount of the crystalline polyester resin, 50 mass % or more is a crystalline polyester resin obtained by polycondensing a dicarboxylic acid having a number of carbon atoms in the range of 9 to 14 and a dialcohol having a number of carbon atoms in the range of 9 to 14.

3. The electrostatic charge image developing toner according to claim 1, wherein all of the crystalline polyester resins is a crystalline polyester resin obtained by polycondensing a dicarboxylic acid having a number of carbon atoms in the range of 9 to 14 and a dialcohol having a number of carbon atoms in the range of 9 to 14.

4. The electrostatic charge image developing toner according to claim 1,
wherein the crystalline polyester resin has an acid value in the range of 20 to 30 mg KOH/g.

5. The electrostatic charge image developing toner according to claim 1,
wherein the amorphous polyester resin contains a constituent unit derived from a dicarboxylic acid having a number of carbon atoms in the range of 9 to 14 or a dialcohol having a number of carbon atoms in the range of 9 to 14 in an amount of 1 to 20 mol %.

6. The electrostatic charge image developing toner according to claim 1,
wherein the number of carbon atoms of the dicarboxylic acid having a number of carbon atoms in the range of 9 to 14 and the number of carbon atoms of the dialcohol having a number of carbon atoms in the range of 9 to 14 are the same.

7. The electrostatic charge image developing toner according to claim 1,
wherein the dicarboxylic acid having a number of carbon atoms in the range of 9 to 14 is sebacic acid, and the dialcohol having a number of carbon atoms in the range of 9 to 14 is 1,10-decanediol.

8. The electrostatic charge image developing toner according to claim 1,
wherein the crystalline polyester resin is a hybrid crystalline polyester resin in which a crystalline polyester polymer segment and a vinyl polymer segment having a constituent unit derived from styrene are chemically bonded.

9. The electrostatic charge image developing toner according to claim 1,
wherein the amorphous polyester resin is a hybrid amorphous polyester resin in which an amorphous polyester polymer segment and a vinyl polymer segment having a constituent unit derived from styrene are chemically bonded.

10. The electrostatic charge image developing toner according to claim 1, further comprising a Fischer-Tropsch wax.

11. The electrostatic charge image developing toner according to claim 1,
wherein a value of a ratio Wₐₚ/W_{cp} of a contentthe amorphous polyester resin to a content W_{cp} of the crystalline polyester resin in the toner particle is in the ra Wₐₚ of nge of 0.5 to 1.5.

12. An electrostatic charge image developer containing the electrostatic charge image developing toner according to claim 1.
